(19) United States
(12) Patent Application Publication
(10) Pub. No.: US 2007/0028217 A1
(43) Pub. Date: Feb. 1, 2007

(54) Testing software using verification data defined independently of the testing code

(75) Inventors: Rajeshdutta Shyamdeva Mishra, Issaquah, WA (US); Vladislav Rashevsky, Redmond, WA (US)

Correspondence Address: WOLF GREENFIELD (Microsoft Corporation);C/O WOLF, GREENFIELD & SACKS, P.C., FEDERAL RESERVE PLAZA, 600 ATLANTIC AVENUE, BOSTON, MA, 02210-2206, US

(73) Assignee: Microsoft Corporation, Redmond, WA (US)

(21) Appl. No.: 11/193,294

(22) Filed: Jul. 29, 2005

(51) Int. Cl. G06F 9/44

(52) U.S. Cl. 717/124

(57) ABSTRACT

Systems, methods, data structures and software for testing software, in which the testing code and the verification data are independent from each other A variation map may specify one or more testing (e.g., automation) modules, and may specify the verification data to apply to the testing module(s). For example, the variation map may specify: specific value(s) for variables (e.g., parameters) of a testing module; type(s) of data patterns to apply to the variables; a number of testing iterations to perform using the testing module; and how to record the results of each iteration. A testing framework may be provided that is configured to use a variation map to test software. The testing framework may be configured to generate verification data using this recognition, and to control the execution of the one or more testing modules specified in the variation map, including supplying the generated verification data to the testing module(s).

### BACKGROUND

A critical component of developing software is testing the software before release, which involves verifying the proper operation of the software for a variety of data. As used herein, “verification data” is data used by testing software to verify proper operation of the software. For example, a software application may include a module (e.g., a method or function) for determining the value of a car based on a variety of factors such as year, make, model, mileage, condition, etc, and the software module may represent each of these factors with a variable. Testing code (e.g., a testing harness or portion thereof) may be programmed to test the module by running several iterations, applying different combinations of values of the variables for each iteration. This test may verify that the module does not crash or otherwise experience a run-time error for each combination, and verify that the module calculates the proper value of the car for each combination, for example, by comparing the results to expected (e.g., predetermined) results.

The one or more test functions defined by the testing code and the verification data used by the testing code are integrated within the same testing code module(s). That is, each testing module defines the verification data that it will use for each test iteration. Thus, if a developer (e.g., quality assurance engineer, software tester, software verification engineer, etc.) wants to change the verification data, the developer must change the testing code itself. For example, the developer must recode and re-compile the source code of the testing module(s) each time the developer wishes to change the verification data.

### SUMMARY

This Summary provides an illustrative context for aspects of the invention, in a simplified form. It is not intended to be used to determine the scope of the claimed subject matter, nor to identify key and/or essential features of the claimed subject matter. These and other aspects of the invention are described more fully below in the Detailed Description.

Described herein are systems, methods, data structures and software for testing software, in which the testing code and the verification data are independent from each other. For example, verification data may be defined in a software abstraction, such as, for example, an extensible markup language (XML) file, separate from the test code. Accordingly, the test code and verification data may be developed and maintained as separate entities. As used herein, a software abstraction including a definition of verification data that is separate from the testing code that uses the verification data is referred to herein as a “test map”. As described in more detail below, MCF provides for a “variation map”, which is an example of a test map.

A test map may specify one or more testing (e.g., automation) modules, and may specify the verification data to apply to the testing module(s). For example, the test map may specify: specific value(s) for variables (e.g., parameters) of a testing module; type(s) of data patterns to apply to the variables; a number of testing iterations to perform using the testing module; how to record the results of each iteration; any of several other parameters described in more detail below; and any suitable combination of the foregoing. The test map may specify data patterns of any of a variety of types including, but not limited to: simple name-value pairs; regular expressions; specific or all permutations of multi-key value pairs; Pairwise Independent Combinatorial Testing (PICT) patterns; complex data (e.g., binary or an XML blob) patterns; other data pattern types; or any suitable combination of the foregoing. These various pattern types are described in more detail below.

A test map that specifies a plurality of (i.e., two or more) testing modules may define the order in which the testing modules are executed, for example, based on the manner in which the references to the testing modules are arranged. For example, the test map may specify a plurality of variations of the verification data, and each variation may specify a particular testing module and the parameter values (e.g., data patterns and/or specific values) to apply to the testing module. Further, these variations may be arranged as groups, and testing parameter values may be defined for the groups. The arrangement of the variations and/or groups may determine the order in which the specified testing modules are executed. Thus, a test map may define a hierarchical structure, which is some embodiments may include three levels: the test map itself at a highest level, one or more group nodes at a second level and one or more variations at a lowest level. Parameter values may be defined for each abstraction at each level (e.g., map itself, group, variation), and these values may be applied to each abstraction within the abstraction for which they are defined.

A testing framework (e.g., a Managed Common Code Framework (MCF) available from Microsoft Corporation of Redmond, Wash.) may be provided that is configured to use a test map to test software. As used herein a “testing framework” is a re-usable software structure including one or more predefined software components (e.g., abstract and/or concrete classes of an object-oriented programming language) that assist in testing software. For example, the testing framework may receive a command to execute a software test, the command specifying a test map. The testing framework may be configured to recognize the syntax and semantics of a test map, and generate verification data based on this recognition. For example, the framework may be configured to recognize the data patterns (e.g., of any of a variety of the types disclosed herein), values and/or other parameters specified in the test map, and generate values based on these parameters. The framework may control the execution of the one or more testing modules specified in the test map, and may supply the generated verification data to the testing module(s) in doing so. The framework may control the order in which testing modules are executed based on the arrangement of the testing module references in the test map, for example, based on the hierarchical structure of the test map as described above. In some embodiments, the testing framework may be configured to generate random values as part of generating verification data, and the variation map may specify seed(s) for generating the random values.

A user interface may be provided that enables a user (e.g., a developer) to specify execution of a software test in accordance with a test map. For example, the user may enter a command specifying an executable file, which calls into the corresponding framework, and may specify a test map as a value of a test map parameter for the executable file. The framework may be configured to read this parameter to identify the test map. The parameter for specifying the test map may be referred to as a command-line parameter, and the specified test map as a command-line parameter value. Other command-line parameters and/or values of these parameters may be specified, and each such parameters and/or value may affect execution of the software test. Specifying a command-line parameter without a value may result in a default value for the parameter being applied. Each command-line parameter may correspond to a parameter that can be defined within a test map itself, for example, any test map parameters defined herein. Command-line parameters enable developers to dynamically program a software test at run-time.

Using a test map as described herein may be considered a data-driven approach to defining a software test. That is, rather than defining the flow of a testing process in one or more testing modules, which define functions, methods, procedures, etc., the flow is defined by a data structure—e.g., a test map. Based on the structure and parameters provided by the variable map, a testing framework determines the flow of the software test, and executes accordingly, based on its recognition of the syntax and semantics of the test map.

As described, a test map may specify values for variables of a testing module and/or types of patterns to apply to the variables, and a test framework may be configured to interpret the specified values and data patterns to generate data for use by the testing module. In some embodiments of the invention, described in more detail below, the test framework is configured to generate relatively large amounts of verification data, based on a relatively small amount of values and/or patterns specified in the test map. Accordingly, by specifying relatively few values and/or patterns in a test map, a user can control the generation of a relatively large amount of verification data to be used by one or more testing modules as part of a software test. The ability to generate large amounts of verification data, based on relatively few user-specified values and/patterns is not limited to the use of test maps. In some embodiments of the invention, the relatively few values and/or patterns may be specified in a testing module itself, and large amounts of verification data generate therefrom.

In an embodiment of the invention, a system is provided for executing a software test on at least a portion of a software application. The system includes at least one testing module defining one or more functions to perform on the at least portion of software code, and a data structure separate and distinct from the at least one testing module. The data structure specifies verification data to be applied by the at least one testing module.

In an aspect of this embodiment, the data structure is formatted in accordance with an extensible markup language.

In another aspect of this embodiment, the system includes a testing framework operative to execute the software test based on the data structure.

In another aspect of this embodiment, the testing framework is operative to receive an instruction to execute a software test using the data structure, and the testing framework controls execution of the software test based on the data structure in response to receiving the instruction.

In yet another aspect of this embodiment, the instruction specifies one or more parameters corresponding to the data structure, and the testing framework is operative to control execution of the at least one testing module based at least in part on a value of the one or more parameters.

In another aspect of this embodiment, the data structure includes a reference to the at least one testing module. Further, the testing framework is operative to interpret the data reference, including generating values of the verification data and identifying the at least one testing module from the reference and operative to execute the at least one testing module using the generated values.

In another aspect of this embodiment, the at least one testing module includes a plurality of testing modules, and the data structure defines an order in which the testing modules are to be executed and/or a number of times each testing module is to be executed.

In yet another aspect of this embodiment, the data structure specifies a data pattern to be used to generate values of the verification data.

In another aspect of this embodiment, the system includes a testing framework operative to execute the software test based on the data structure, including generating values of the verification data based on the specified data pattern.

In another aspect of this embodiment, the testing framework is operative to generate random values based on the specified data pattern.

In yet another aspect of this embodiment, the specified data pattern is one of the following types of data patterns: a simple name-value pair; a regular expression; a permutation of multi-key value pairs; a Pairwise Independent Combinatorial Testing pattern; a complex data pattern.

In another embodiment, a software test is executed on at least a portion of a software application. A data structure specifying verification data to be applied by at least one testing module is interpreted, the at least one testing module defining one or more functions to perform on the at least portion of software code. In response to the interpretation, the at least one testing module is executed one or more times using the verification data.

In an aspect of this embodiment, the data structure is formatted in accordance with an extensible markup language, and interpreting includes interpreting the data structure in accordance with the extensible markup language.

In another aspect of this embodiment, the data structure includes a reference to the at least one testing module, and the interpreting includes interpreting the data reference, generating values of the verification data and identifying the at least one testing module from the reference. further, the executing includes executing the at least one testing module using the generated values.

In yet another aspect of this embodiment, the at least one testing module includes a plurality of testing modules, and the data structure defines an order in which the testing modules are to be executed and/or a number of times each testing module is to be executed. Further, the interpreting, and the interpreting includes interpreting the order and/or the number of times.

In another aspect of this embodiment, the data structure specifies a data pattern to be used to generate values of the verification data. Further, values of the verification data are generated based on the specified data pattern.

In another aspect of this embodiment, the act generating includes generating random values based on the specified data pattern.

In another aspect of this embodiment, the specified data pattern is one of the following types of data patterns: a simple name-value pair; a regular expression; a permutation of multi-key value pairs; a Pairwise Independent Combinatorial Testing pattern; a complex data pattern. Further, the generating includes generating values of the verification data based on the type of the specified data pattern.

In yet another aspect of this embodiment, an instruction to execute a software test using the data structure is received, and the interpreting is performed in response to the reception.

In another aspect of this embodiment, the instruction specifies one or more parameters corresponding to the data structure, and the execution includes executing the at least one testing module based at least in part on a value of the one or more parameters.

In another embodiment of the invention, a computer program product is provided. The product includes a computer-readable medium, and computer-readable signals stored on the computer-readable medium defining instructions that, as a result of being executed by a computer, instruct the computer to perform the method of the embodiment of the invention described in the preceding paragraphs and/or one or more aspects thereof described in the preceding paragraphs.

In yet another embodiment, a computer-readable medium having computer-readable signals stored thereon is provided. The computer-readable signals define a data structure for testing at least a portion of software code. The data structure includes a reference to at least one testing module including one or more functions to perform on the at least portion of software code, and one or more definitions of verification data to be applied by at least one testing module when performing the one or more functions.

In an aspect of this embodiment, the data structure is formatted in accordance with an extensible markup language.

In another aspect of this embodiment, the at least one testing module includes a plurality of testing modules, and wherein the data structure defines an order in which the testing modules are to be executed and/or a number of times each testing module is to be executed.

In another aspect of this embodiment, the data structure specifies a data pattern to be used to generate values of the verification data.

In yet another aspect of this embodiment, the specified data pattern is one of the following types of data patterns: a simple name-value pair; a regular expression; a permutation of multi-key value pairs; a Pairwise Independent Combinatorial Testing pattern; a complex data pattern.

Other advantages, novel features, and objects of the invention, and aspects and embodiments thereof, will become apparent from the following detailed description of the invention, including aspects and embodiments thereof, when considered in conjunction with the accompanying drawings, which are schematic and which are not intended to be drawn to scale. In the figures, each identical or nearly identical component that is illustrated in various figures is represented by a single numeral. For purposes of clarity, not every component is labeled in every figure, nor is every component of each embodiment or aspect of the invention shown where illustration is not necessary to allow those of ordinary skill in the art to understand the invention.

### BRIEF DESCRIPTION OF THE DRAWINGS

FIG. 1 is a block diagram illustrating an example of a system for testing software using verification data that is separate from the testing code, according to some embodiments of the invention;

FIG. 2 is a block diagram illustrating an example of a system for testing software using MCF and verification data that is separate from the testing code, according to some embodiments of the invention;

FIG. 3 is an illustrative example of a test map, according to some embodiments of the invention;

FIG. 4 is another illustrative example of a test map, according to some embodiments of the invention;

FIG. 5 is a block diagram illustrating an example of execution flow of a test map, according to some embodiments of the invention;

FIG. 6 illustrates an example of a variation included within a testing map that specifies to perform all permutations of multi-key value pairs, according to some embodiments of the invention;

FIG. 7 illustrates an example of a variation specifying the generation of verification data according to a pict pattern, according to some embodiments of the invention;

FIG. 8 illustrates an example of a variation for specifying complex data to be passed to a testing module, according to some embodiments of the invention;

FIG. 9 is a block diagram illustrating an example of a method of testing software using verification data that is separate from the testing code, according to some embodiments of the invention;

FIG. 10 is a block diagram illustrating an example of a computer system on which some embodiments of the invention may be implemented; and

FIG. 11 is a block diagram illustrating an example of a storage system that may be used as part of the computer system to implement some embodiments of the invention.

### DETAILED DESCRIPTION

Although some embodiments described herein are described primarily in relation to using MCF available from Microsoft Corporation, the invention is not so limited. Any of a variety of other testing frameworks, configured properly, can be used. Further, although some embodiments of the invention described herein are described in relation to using a test map implemented in XML, the invention is not so limited. Other types of software abstractions, formatting technologies and/or programming languages may be used, and are intended to fall within the scope of the invention.

The function and advantage of these and other embodiments of the present invention will be more fully understood from the examples described below. The following examples are intended to facilitate a better understanding and illustrate the benefits of the present invention, but do not exemplify the full scope of the invention.

As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, shall be closed or semi-closed transitional phrases, as set forth, with respect to claims, in the United States Patent Office Manual of Patent Examining Procedures (Eighth Edition, Revision 2, May 2004), Section 2111.03.

### Examples

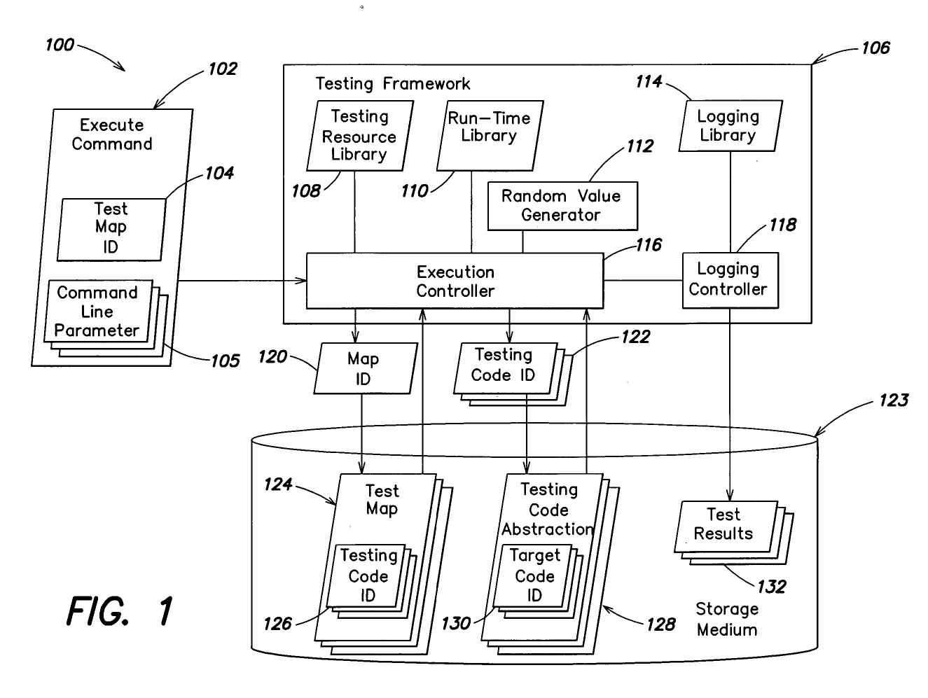

FIG. 1 is a block diagram illustrating an example of a system 100 for testing software using verification data that is separate from the testing code, according to some embodiments of the invention. System 100 is not intended to limit the scope of the invention. Any of numerous other implementations of a system for testing software using verification data that is separate from the testing code, for example, variations of system 100, are possible and are intended to fall within the scope of the invention.

System 100 may include any of: testing framework 106; storage medium 123; other components; or any suitable combination of the foregoing. Testing framework 106 may be a testing harness, which may include a plurality of resources (e.g., dll, executables, other) to assist in executing scenarios specified in testing of maps. For example, testing framework may include any of: execution controller 116; testing resource library 108; run-time library 110; random value generator 112; logging library 114; logging controller 118; other components; or any suitable combination of the foregoing. These components of testing framework 106 are described below in more detail.

Storage medium 123 may store a plurality of test maps 124, each test map specifying one or more testing code ID 126. Test map 124 may be a software abstraction (e.g., an XML file) which specifies a testing scenario to be executed by the testing framework 106. Each testing code ID 126 included with a test map may specify a testing code abstraction 128 (i.e., a testing module) such as, for example, a class written in any of a variety of programming languages and/or a custom plug-in as described in more detail below. Each testing code abstraction 128 may include a target code ID 130, which may specify the actual software code for which the test is being performed. For example, the target code may be a software application and/or a portion thereof.

The execution controller 116 may be configured to receive an execute command 102 from a user (e.g., through a console executable as described below), and the execute command 102 may include a test map ID 104. The execution controller may use the specified test map ID 104 (i.e., map ID 120) to access the identified test map from storage medium 123. The execution controller 116 then may use the one or more testing code IDs 126 specified within the retrieved test map (i.e., testing code ID(s) 122) to retrieve the identified testing code abstraction(s) 128 from storage medium 123. Using testing resource library 108, run-time library 110 and random value generator 112, execution controller 116 may generate verification data in accordance with the retrieved test map and apply the verification data to the retrieved one or more testing code abstractions according to the test map. Each testing code abstraction is applied to the target code that it identifies.

Execution controller 116 may be configured to interact with logging controller 118 to record test results 132 in storage medium 123 and/or display some or all of the these results to a user. The test results 132 and the results displayed to a user may be based on parameters supplied within the test map interpreted by controller 116, and logging controller 118 may utilize logging library 114 to produce the results.

Execute command 102 also may include one or more command line parameters 105, and may include a value for one or more of the command line parameter(s). Execution controller 116, in combination with any of the resources at its disposal (e.g., 108 and 110), may be configured to interpret the one or more specified command line parameters and/or parameter values when controlling execution of the test map specified by test map ID 104. These command line parameters may control, at least in part, aspects of the testing scenario specified by the test map, as will be described in more detail below.

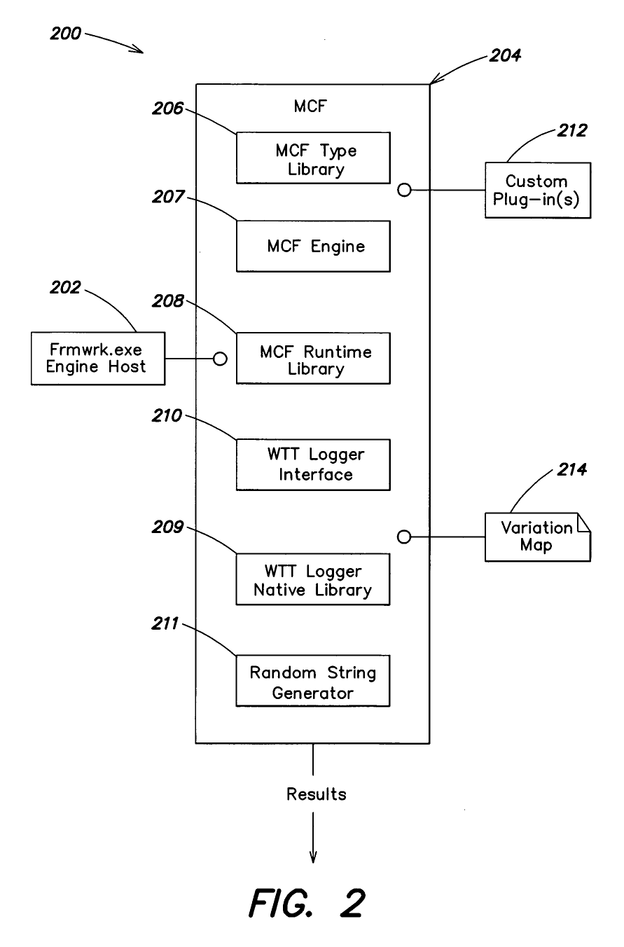

In some embodiments of the invention, the system 100 may be implemented in accordance with MCF, for example, in accordance with the system 200 illustrated in FIG. 2. For example, testing resource library 108, run-time library 110, random value generator 112, logging library 114, execution controller 116, logging controller 118, test map(s) 124 and testing code abstraction(s) 128 may be implemented as MCF type library 206, MCF runtime library 208, random string generator 211, WTT logger native library 209, MCF engine 207, WTT logger interface 210, variation map 214 and custom plug-in(s) 212, respectively, described below in more detail in relation to FIG. 2.

FIG. 2 is a block diagram illustrating an example of a system 200 for testing software using MCF and verification data that is separate from the testing code, according to some embodiments of the invention. System 200 is referred to throughout the specification as an example, but is not intended to limit the scope of the invention. Any of numerous other implementations of a system for testing software using MCF and verification data that is separate from the testing code, for example, variations of system 200, are possible and are intended to fall within the scope of the invention.

System 200 may include any of: engine host 202; MCF 204; custom plug-in(s) 212; variation map 214; other components; or any suitable combination of the foregoing. The engine host 202 may be a console executable, and may be a thin layer around MCF engine 207, which may be a dll assembly containing components for implementing the functionality/logic of MCF 204. MCF 204 may be a harness which consists of a number of dlls and executables used to run scenarios defined in variation maps (e.g., variation map 214). A variation map may be an XML file which contains a description of a scenario to be executed by MCF 204. It may reference particular plug-in assemblies (e.g., custom plug in(s) 212) and types within assemblies. A custom plug-in 212 may be a user-created assembly including types that can be executed by MCF 204. Components 204, 206, 207, 208, 209, 210, 211, 212 and 214 may be implemented, generally, as described above with respect to their corresponding component from system 100, and as described below in more detail. In some embodiments, the components of system 200 are implemented with the MCF components listed in Table 2 below.

TABLE 2
Examples of MCF Components

| File Name | Description |
|---|---|
| frmwrk.exe | MCF engine host |
| Microsoft.Test.Infra.Frmwrk.Types.dll | MCF type library |
| Microsoft.Test.Infra.FrmwrkEE.dll | MCF engine |
| Microsoft.Test.Infra.RTLib.dll | MCF runtime library |
| Microsoft.Wtt.Log.dll | Windows Test Technology |
| | (WTT) Logger C# interface |
| WTTlog.dll | WTT Logger native library |
| strgenrt.dll | Random String generator |

In some embodiments, testing framework 106 and/or MCF 204 may be configured to handle testing code abstractions 128 and custom plug-ins 212, respectively, written in any of a plurality of programming languages such as, for example, C++, VB.NET, C++, MC++, any of a variety of other programming languages (e.g., any of those disclosed herein), or any suitable combination of the foregoing.

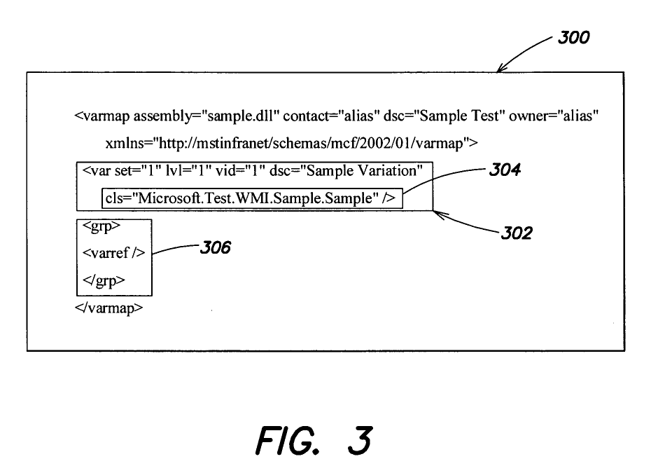

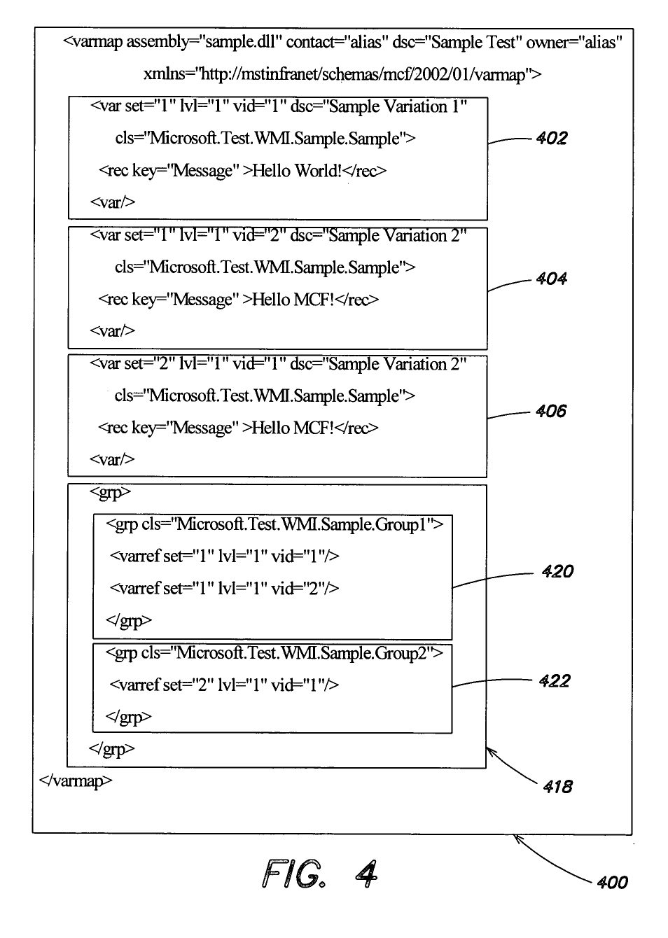

FIG. 3 is an illustrative example of a test map 300 (e.g., test map 124 and/or variation map 214). This is a relatively simple example in which there is only a single variation 302, specifying a single testing code abstraction (i.e., resource) 304, and a single group 306. Several of the terms that appear in FIG. 3 (and FIG. 4) are used throughout the application, in particular with respect to embodiments that employ MCF. The meaning of these terms is as shown in Table 1 below.

TABLE 1
Variation Map Term Meanings

| Term | Description |
|---|---|
| <varmap> | test map XML node is the container of the test map |
| <grp> | group XML node is there for grouping semantics |
| <var> | variation XML node describes a test variation |
| <varref/> | variation reference node is contained in the group node and |
| | describes the variations that make up a particular group |
| assembly | this attribute describes the test suite assembly containing the |
| | test - one test assembly per test suite |
| contact | use this attribute to list out contacts for this test suite |
| set, lvl, vid | these form the variation triplet and uniquely identify a test |
| cls | this attribute defines the implementation class for a test var |

As illustrated in FIG. 3, variation 302 specifies the class “Microsoft.Test.WMI.Sample.Sample”. This class may be a testing code abstraction 128 and/or a custom plug-in 212, and may include the following code:

```
using System;
using Microsoft.Test.Infra.Frmwrk;
namespace Microsoft.Test.WMI.Sample
{
  public class Sample: IRun
  {
    public void Run(IContext ctx)
    {
      ctx.Framework.Alw(“Hello, World!”);
    }
  }
}
```

To execute the testing scenario specified by test map 300, a user may enter the following text at an execution console: “C:> frmwrk.exe /m:sample.xml,” which may result in the following test results (e.g., test results 132) being displayed on the user console and/or record on a storage medium (e.g., storage medium 123):

*LOG_START*-
Start: Set=1 Level=1 Var=1 Seed=62686357 [Sample Variation 1]
[17:09:57] <3816> <940> Alw sample - Hello World!
[17:09:57] <3816> <940> Alw mcfdemo.pict - Set=1 Level=1
Var=1 [Sample Variation]: VAR_PASS
End: Pass, Set=1 Level=1 Var=1 Pid=1,1 Seed=62686357
[Sample Variation]
Summary: Total=1, Passed=1, Failed=0, Blocked=0, Warned=0,
Skipped=0
*LOG_DONE*-

FIG. 4 is an illustrative example of a more complex variation map 400, with several attributes and other information abbreviated for clarity. Variation map 400 includes a plurality of variations 402, 404 and 406, and group 418, which contains groups 420 and 422.

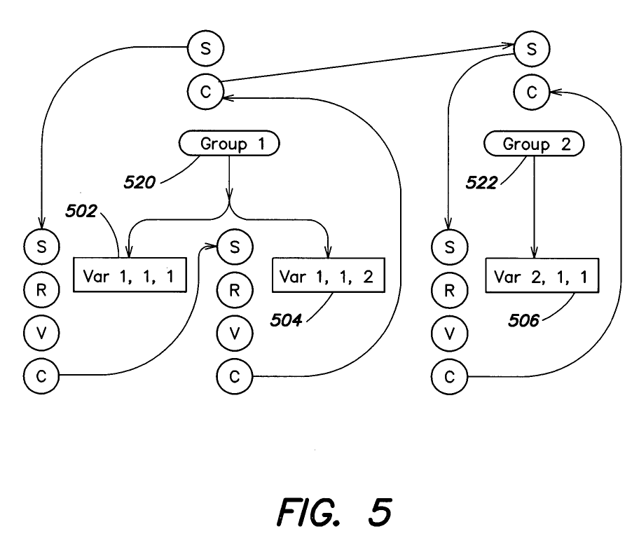

As described above, the arrangement of variations and/or groups within a test map may control the order in which variation data is generated and test code executed. For example, the arrangement for variations 402, 404 and 406 and groups 418, 420 and 422 in FIG. 4 may result in the execution flow illustrated in FIG. 5.

FIG. 5 is a block diagram illustrating an example of an execution flow of a test map (e.g., test map 400), according to some embodiments of the invention. In FIG. 5, the following symbols have the following meanings: S=setup method: R=run method; V=verification method; and C=cleanup method. Variations 502, 504 and 506 correspond to variations 402, 404 and 406 of test map 400, respectively, and groups 520 and 522 correspond to groups 420 and 422, respectively. As is described in more detail below, the execution of a setup, run, verification or cleanup method for a group or variation may be controlled by specifying certain values for particular parameters.

Testing framework 106 and/or MCF 204 may provide one or more resources to assist in executing setup, run, verify and cleanup methods such as, for example, interfaces (i.e., contracts) corresponding to each of these types of methods (e.g., with names like ISetup, IRun, IVerify and/or ICleanup). Testing modules (e.g., plug-ins) may employ one or more of these resources (e.g., interfaces) to define testing functionality.

Testing framework 106 and/or MCF 204 may be configured to generate verification data based on parameters, value and/or data patterns specified within a test map (e.g., test map 124 and/or variation map 214). Testing resource library 108 and/or MCF type library 206 may include one or more resources to assist in the generation and retrieval of verification data. For example, MCF 204 may define an interface to assist in the generation and/or retrieval of verification data, which may include the following code:

```
public interface IRecordList
{
  bool  HasKey(string key);
  string  GetSingleValue(string key);
  string[ ] GetAllKeys( );
  string[ ] GetValues(string key);
}
```

A test map (e.g., test map 124 and/or variation map 214) may include one or more records specifying the variation data to be used as part of a testing scenario. For example, a record may specify specific values for the data and/or patterns to be used to generate the data. Any of a variety of types of data patterns may be specified including, but not limited to: simple name-value pairs, regular expressions; specific or all permutations of multi-key value pairs; PICT patterns; complex data patterns; other data pattern types; or any suitable combination of the foregoing. For example, the specific value for a variable of a test module may be specified as follows:

```
<var set=“1” lvl=“1” vid=“1” dsc=“Sample Variation”
    cls=“Microsoft.Test.WMI.Sample.Sample”>
  <rec key=“Message” >Hello World!</rec>
<var/>
```

As shown in this example, the term “key” may be used to indicate that a value and/or data pattern is to be provided for a variable to be passed into a testing module. In the example above, the variable is given the name Message and the value “Hello World!”

The testing framework may be configured to interpret the above example as specifying that the value “Hello World” be passed into the class named “Microsoft.Test.WMI.Sample.Sample”. This class may be of interface type IRun and may be defined as follows:

```
  public class Sample: IRun
  {
    public void Run(IContext ctx)
    {
      string msg = ctx.RecordList.GetSingleValue(“Message”);
      ctx.Framework.Alw(msg);
    }
}
```

The following markup code may be used to define a regular expression for a variation node:

```
<var set=“1” lvl=“1” vid=“1” dsc=“Sample Variation”
    cls=“Microsoft.Test.WMI.Sample.Sample”>
  <rec key=“Message” regex=“true”>Hello (World|MCF)!</rec>
<var/>
```

In the above example, the phrase: regex=“true” indicates that the value to follow will be a regular expression. In the above example, the regular expression is Hello (World|MCF)!. As described in Table 10 below, the pattern (a|b) generates a or b. Accordingly, the above regular expression would result in the values “Hello World!” and “Hello MCF!.” The testing framework (e.g., testing framework 106 and/or MCF 204) may be configured to recognize the expression “regex” and interpret the foregoing regular expression as described above, for example, in accordance with Table 10 below. Further, the code of the class “Microsoft.Test.WMI.Sample.Sample” may be the same as the sample code of the same name provided above, with the testing framework handling the passing of the different values for the variable into this class based on the specified regular expression.

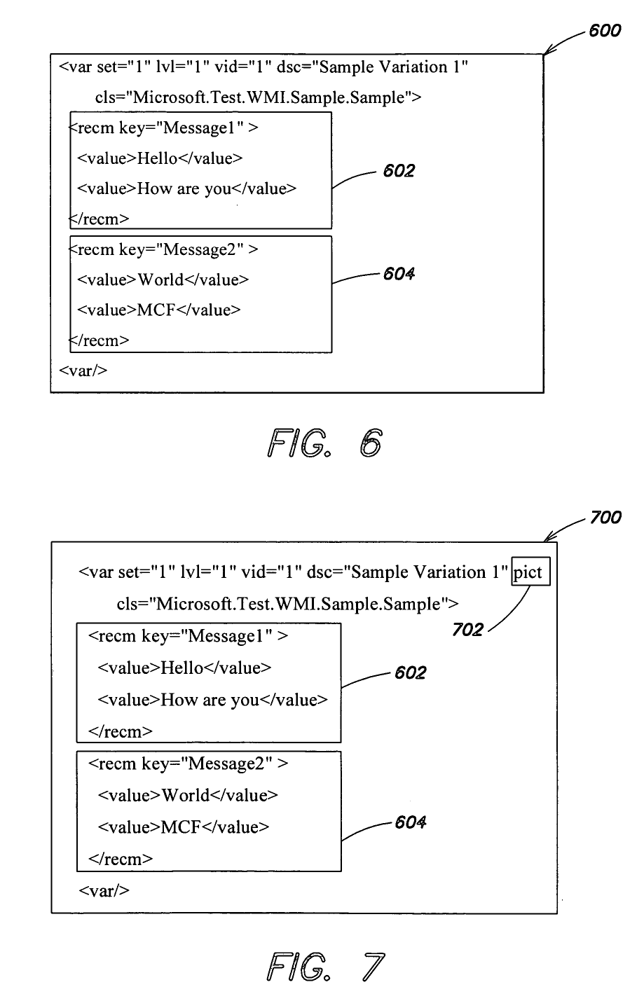

FIG. 6 illustrates an example of a variation 600 included within a testing map that specifies to perform all permutations of multi-key value pairs, according to some embodiments of the invention. Variation 600 includes multi-value records 602 and 604, as indicated by the term “recm” on the first line of the record. The term “recm” specifies that the following variable (Message1 for multi-value record 602) can have more than one value, and the “value” nodes specify the values that the variable can take. For example, in record 602, the variable Message1 can have the value “Hello” or “How are you”, and record 604 specifies that the variable Message2 can have the value “World” or the value “MCF.”

The testing module specified in variation 600, Microsoft.Test.WMI.Sample.Sample, may include the following code:

```
public class Sample: IRun
{
  public void Run(IContext ctx)
  {
    string msg1 = ctx.RecordList.GetSingleValue(“Message1”);
    string msg2 = ctx.RecordList.GetSingleValue(“Message2”);
    ctx.Framework.Alw(msg1 + “ ” + msg2 + “!”);
  }
}
```

The testing framework (framework 106 or 204) may be configured to recognize the multi-value record term “recm” and to generate verification data. This verification data may include all possible permutations of all multi-value records; i.e., all combinations of each value of the multi-value record with all possible values of other multi-value records specified for a variation. The testing framework may pass each combination to the testing module specified by the variation (e.g., the testing module provided above). Applying such generated verification data to the testing module above may result in the following output:

Hello World!
Hello MCF!
How are you World!
How are you MCF

Other parameters within a test map and/or command line parameters may be used to limit the number of combinations generated by the testing framework. The testing framework may be configured to recognize the parameter “pid” (permutation ID), for example, as a command line parameter, as the following examples illustrate:

frmwrk.exe /m:sample.xml ‘run all permutations of M1 & M2;
frmwrk.exe /m:sample.xml /pid:1,1 ‘run only combination 1,1 (Hello
World!); and
frmwrk.exe /m:sample.xml /pid:1-2,2 ‘run combinations 1,2 and 2,2.

FIG. 7 illustrates an example of a variation 700 specifying the generation of verification data according to a PICT pattern, according to some embodiments of the invention. Variation 700 is the same as variation 600 except for the parameter 702 (“pict”) appearing on the variation node, which indicates that a PICT pattern is to be applied to the values specified in multi-value records 602 and 604. Unlike variation 600, which specifies to combine all permutations (or specific permutations using the pid parameter) of multi-key value pairs, PICT generates less than all permutations. For example, if there are three or more variables, and each variable can have more than one value, the testing framework will not generate all possible permutations of these variables. Rather, the testing framework will apply a PICT algorithm that generates all possible permutations of all pairs of variables. For each pair of variables for which all permutations are generated, the values of the other variables for these permutations is not considered (i.e., they are “don't care” values). By applying such a PICT algorithm, the amount of variation data can be greatly reduced, particularly as the number of variables and/or values for variables grows larger.

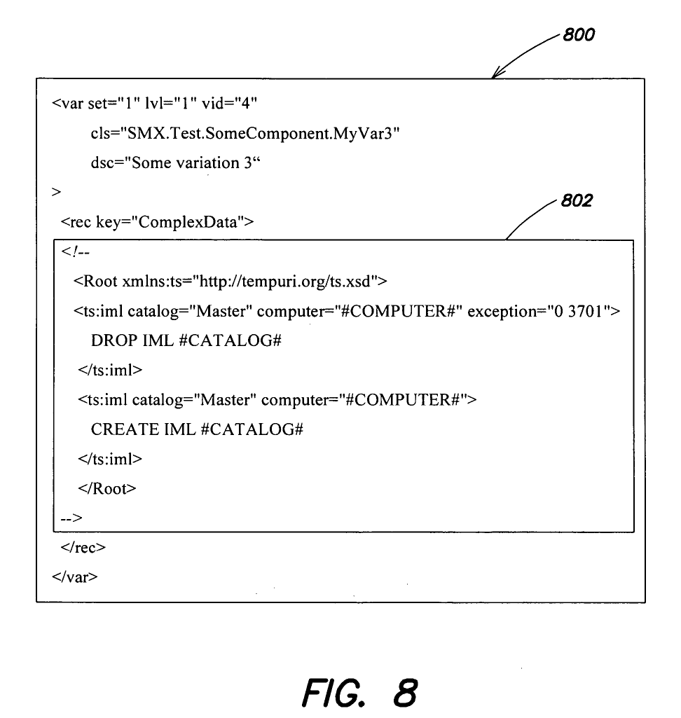

FIG. 8 illustrates an example of a variation 800 for specifying complex data to be passed to a testing module, according to some embodiments of the invention. Variation 800 may include a complex data record 802, identified as such based on the term “!--” appearing on the first line of the complex data record 802.

Systems 100 and/or 200, and components thereof, may be implemented using any of a variety of technologies, including software (e.g., C, C#, C++, Java, or a combination thereof), hardware (e.g., one or more application-specific integrated circuits), firmware (e.g., electrically-programmed memory) or any combination thereof. One or more of the components of systems 100 and/or 200 may reside on a single device (e.g., a computer), or one or more components may reside on separate, discrete devices. Further, each component may be distributed across multiple devices, and one or more of the devices may be interconnected.

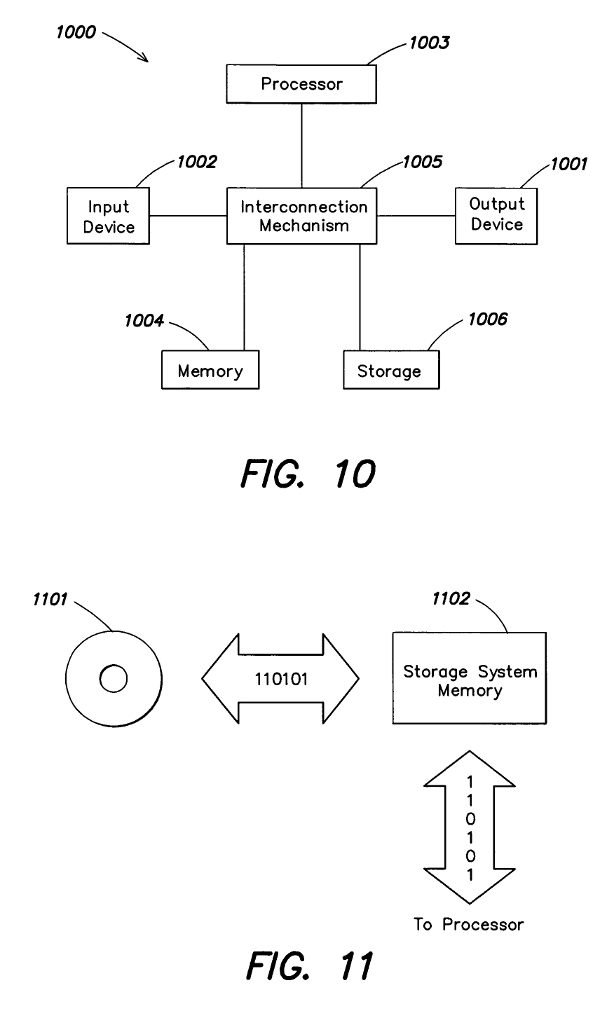

Further, on each of the one or more devices that include one or more components of systems 100 and/or 200, each of the components may reside in one or more locations on the system. For example, different portions of the components of these systems may reside in different areas of memory (e.g., RAM, ROM, disk, etc.) on the device. Each of such one or more devices may include, among other components, a plurality of known components such as one or more processors, a memory system, a disk storage system, one or more network interfaces, and one or more busses or other internal communication links interconnecting the various components. Systems 100 and/or 200, and components thereof, may be implemented using a computer system such as that described below in relation to FIGS. 10 and 11.

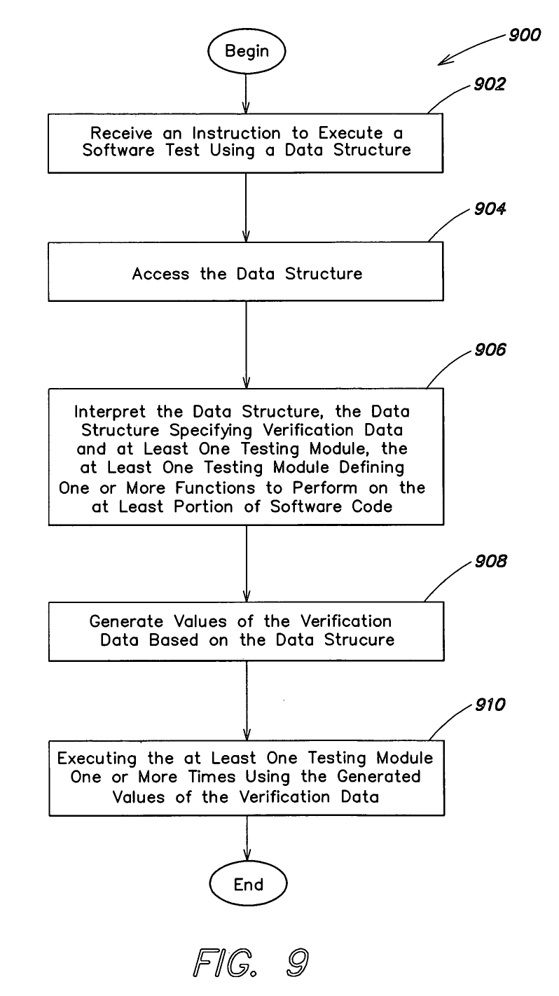

FIG. 9 is a block diagram illustrating an example of a method 900 of testing software using verification data that is separate from the testing code, according to some embodiments of the invention. Method 900 is not intended to limit the scope of the invention. Any of numerous other implementations of a method of testing software using verification data that is separate from the testing code, for example, variations of method 900, are possible and are intended to fall within the scope of the invention. Method 900 and/or acts thereof may be performed by system(s) 100 and/or 200 in accordance with the descriptions thereof described above.

In Act 902, an instruction to execute a software test using a data structure may be received. For example, as described above in relation to FIGS. 1 and 2, an execute command 102 may be received including a test map ID 104 and one or more command line parameters 105, for example, by an engine host or other component of a testing framework (e.g., 106 or 204).

In Act 904, the data structure may be accessed. For example, as described above in relation to FIGS. 1 and 2, the test map 124 (e.g., variation map 214) specified by the test map ID 104 may be accessed, for example, by execution controller 116 (e.g., MCF engine 207).

The data structure may specify verification data and at least one testing module, the at least one testing module defining one or more functions to perform on the at least portion of software code. In Act 906, the data structure may be interpreted. For example, as described above, the verification data specified by the data structure may be specific value(s) and/or data pattern(s) of any of a variety of types. The testing module may be specified by a testing code ID 126, as described above, and may point to a testing code abstraction 128 stored on storage medium 123. This testing code abstraction may be any of a plurality of types of abstractions such as a custom plug-in 212 described above in relation to FIG. 2.

In Act 908, values of the verification data may be generated based on the data structure. For example, as described above in relation to FIGS. 1 and 2, the execution module 116 (e.g., 207) may be configured to generate verification data based on the test map using any of a variety of resources such as, for example, testing resource library 108 (e.g., MCF type library 206), run-time library 110 (e.g., MCF run-time library 208) and/or random value generator 112 (e.g., random string generator 211).

In Act 910, the at least one testing module may be executed one or more times using the generated values of the verification data. For example, as described above in relation to FIGS. 1 and 2, execution controller 116 (e.g., MCF engine 207) may be configured to retrieve the testing code abstraction 128 (e.g., custom plug-in 212) specified by the testing code ID 126 and apply the generated values to the testing code to produce test results 132. In another act of method 900 (not shown), test results may be stored on a storage medium (e.g., medium 123) and/or reported to a user (e.g., on a user interface display).

Method 900 may include additional acts. Further, the order of the acts performed as part of method 900 is not limited to the order illustrated in FIG. 9, as the acts may be performed in other orders and/or one or more of the acts may be performed in series or in parallel, at least partially.

Method 900, acts thereof, and various embodiments and variations of this method and these acts, individually or in combination, may be defined by computer-readable signals tangibly embodied on one or more computer-readable media, for example, non-volatile recording media, integrated circuit memory elements, or a combination thereof. Computer readable media can be any available media that can be accessed by a computer. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, other types of volatile and non-volatile memory, any other medium which can be used to store the desired information and which can accessed by a computer, and any suitable combination of the foregoing.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, wireless media such as acoustic, RF, infrared and other wireless media, other types of communication media, and any suitable combination of the foregoing.

Computer-readable signals embodied on one or more computer-readable media may define instructions, for example, as part of one or more programs, that, as a result of being executed by a computer, instruct the computer to perform one or more of the functions described herein (e.g., method 900, or any acts thereof), and/or various embodiments, variations and combinations thereof. Such instructions may be written in any of a plurality of programming languages, for example, Java, J#, Visual Basic, C, C#, or C++, Fortran, Pascal, Eiffel, Basic, COBOL, etc., or any of a variety of combinations thereof. The computer-readable media on which such instructions are embodied may reside on one or more of the components of any of systems 100, 300 and 400 described herein, may be distributed across one or more of such components, and may be in transition therebetween.

The computer-readable media may be transportable such that the instructions stored thereon can be loaded onto any computer system resource to implement the aspects of the present invention discussed herein. In addition, it should be appreciated that the instructions stored on the computer-readable medium, described above, are not limited to instructions embodied as part of an application program running on a host computer. Rather, the instructions may be embodied as any type of computer code (e.g., software or microcode) that can be employed to program a processor to implement the above-discussed aspects of the present invention.

It should be appreciated that any single component or collection of multiple components of a computer system, for example, the computer system described in relation to FIGS. 10 and 11, that perform the functions described herein can be generically considered as one or more controllers that control such functions. The one or more controllers can be implemented in numerous ways, such as with dedicated hardware and/or firmware, using a processor that is programmed using microcode or software to perform the functions recited above or any suitable combination of the foregoing.

Various embodiments according to the invention may be implemented on one or more computer systems. These computer systems, may be, for example, general-purpose computers such as those based on Intel PENTIUM-type processor, Motorola PowerPC, Sun UltraSPARC, Hewlett-Packard PA-RISC processors, any of a variety of processors available from Advanced Micro Devices (AMD) or any other type of processor. It should be appreciated that one or more of any type of computer system may be used to implement various embodiments of the invention.

A general-purpose computer system according to one embodiment of the invention is configured to perform one or more of the functions described above. It should be appreciated that the system may perform other functions and the invention is not limited to having any particular function or set of functions.

For example, various aspects of the invention may be implemented as specialized software executing in a general-purpose computer system 1000 such as that shown in FIG. 10. The computer system 1000 may include a processor 1003 connected to one or more memory devices 1004, such as a disk drive, memory, or other device for storing data. Memory 1004 is typically used for storing programs and data during operation of the computer system 1000. Components of computer system 1000 may be coupled by an interconnection mechanism 1005, which may include one or more busses (e.g., between components that are integrated within a same machine) and/or a network (e.g., between components that reside on separate discrete machines). The interconnection mechanism 1005 enables communications (e.g., data, instructions) to be exchanged between system components of system 1000. Computer system 1000 also includes one or more input devices 1002, for example, a keyboard, mouse, trackball, microphone, touch screen, and one or more output devices 1001, for example, a printing device, display screen, speaker. In addition, computer system 1000 may contain one or more interfaces (not shown) that connect computer system 1000 to a communication network (in addition or as an alternative to the interconnection mechanism 1005.

The storage system 1006, shown in greater detail in FIG. 11, typically includes a computer readable and writeable nonvolatile recording medium 1101 in which signals are stored that define a program to be executed by the processor or information stored on or in the medium 1101 to be processed by the program. The medium may, for example, be a disk or flash memory. Typically, in operation, the processor causes data to be read from the nonvolatile recording medium 1101 into another memory 1102 that allows for faster access to the information by the processor than does the medium 1101. This memory 1102 is typically a volatile, random access memory such as a dynamic random access memory (DRAM) or static memory (SRAM). It may be located in storage system 1006, as shown, or in memory system 1004, not shown. The processor 1003 generally manipulates the data within the integrated circuit memory 1004, 1102 and then copies the data to the medium 1101 after processing is completed. A variety of mechanisms are known for managing data movement between the medium 1101 and the integrated circuit memory element 1004, 1102, and the invention is not limited thereto. The invention is not limited to a particular memory system 1004 or storage system 1006.

The computer system may include specially-programmed, special-purpose hardware, for example, an application-specific integrated circuit (ASIC). Aspects of the invention may be implemented in software, hardware or firmware, or any combination thereof. Further, such methods, acts, systems, system elements and components thereof may be implemented as part of the computer system described above or as an independent component.

Although computer system 1000 is shown by way of example as one type of computer system upon which various aspects of the invention may be practiced, it should be appreciated that aspects of the invention are not limited to being implemented on the computer system as shown in FIG. 10. Various aspects of the invention may be practiced on one or more computers having a different architecture or components that that shown in FIG. 10.

Computer system 1000 may be a general-purpose computer system that is programmable using a high-level computer programming language. Computer system 1000 also may be implemented using specially-programmed, special-purpose hardware. In computer system 1000, processor 1003 is typically a commercially available processor such as the well-known Pentium class processor available from the Intel Corporation. Many other processors are available. Such a processor usually executes an operating system which may be, for example, the Windows® 95, Windows® 98, Windows NT®, Windows® 2000 (Windows® ME) or Windows® XP operating systems available from the Microsoft Corporation, MAC OS System X available from Apple Computer, the Solaris Operating System available from Sun Microsystems, Linux available from various sources or UNIX available from various sources. Any of a variety of other operating systems may be used.

The processor and operating system together define a computer platform for which application programs in high-level programming languages are written. It should be understood that the invention is not limited to a particular computer system platform, processor, operating system, or network. Also, it should be apparent to those skilled in the art that the present invention is not limited to a specific programming language or computer system, and that other appropriate programming languages and other appropriate computer systems could also be used.

One or more portions of the computer system may be distributed across one or more computer systems (not shown) coupled to a communications network. These computer systems also may be general-purpose computer systems. For example, various aspects of the invention may be distributed among one or more computer systems configured to provide a service (e.g., servers) to one or more client computers, or to perform an overall task as part of a distributed system. For example, various aspects of the invention may be performed on a client-server system that includes components distributed among one or more server systems that perform various functions according to various embodiments of the invention. These components may be executable, intermediate (e.g., IL) or interpreted (e.g., Java) code which communicate over a communication network (e.g., the Internet) using a communication protocol (e.g., TCP/IP).

It should be appreciated that the invention is not limited to executing on any particular system or group of systems, and that the invention is not limited to any particular distributed architecture, network, or communication protocol.

Various embodiments of the present invention may be programmed using an object-oriented programming language, such as SmallTalk, Java, J# (J-Sharp), C++, Ada, or C# (C-Sharp). Other object-oriented programming languages may also be used. Alternatively, functional, scripting, and/or logical programming languages may be used. Various aspects of the invention may be implemented in a non-programmed environment (e.g., documents created in HTML, XML or other format that, when viewed in a window of a browser program, render aspects of a graphical-user interface (GUI) or perform other functions). Various aspects of the invention may be implemented as programmed or non-programmed elements, or any combination thereof. Further, various embodiments of the invention may be implemented using Microsoft®.NET technology available from Microsoft Corporation.

The function and advantage of the several embodiments of the present invention described above will be more fully understood from the following examples, which involve using MCF, available from Microsoft Corporation. However, it should be appreciated that the invention is not so limited, as other testing frameworks may be used and are intended to fall within the scope of the invention.

1 Overview

The following outlines a version of MCF available from Microsoft Corporation, which may replace a multitude of existing testing frameworks. MCF may make interoperation with different environments easier, and may enable scenario developers to concentrate more on creation of test scenarios instead of concentrating on intricacies of framework infrastructure itself.

2 Architecture and Components

2.1 Overview

A major change provided by MCF over existing frameworks (e.g., Native Framework available from Microsoft Corporation) is a platform change. MCF is based on Common Language Runtime (CLR), thus employing CLR's inherent multiple programming languages/environment support, rich set of libraries and simplicity of development. The need for multiple frameworks covering specific areas of technology should vanish. Unlike Native Framework, which employed source code reuse model, MCF employs a component reuse model. Further, unlike Native Framework, which compiles into one monolithic console executable, MCF consists of several independent pieces which are linked/assembled dynamically in the run-time and can be modified independently of each other. Variation data is no longer a hard-coded part of the testing framework, thus providing more flexibility.

Referring to FIG. 2, variation map 214 is a separate file which can be modified at any point without need to recompile/rebuild the framework program-executable (PE) image. Variation map 214 specifies a tree of group nodes and variation nodes which combine to form an acyclic graph. May 214 allows referencing multiple variations from one group without enumerating them explicitly. It also allows referencing the same variations from multiple groups. See Section 2.2 below for more details.

Execution engine 208 is responsible for scenario execution. It parses a variation map (e.g., map 214) and invokes specified components in the order in which they are specified in variation map 214, for example, as described above in relation to FIG. 5.

Custom plug-in(s) 212 are managed components which implement specific piece of scenario functionality. It can be implemented in any CLR-compliant language.

2.2 Variation Map

2.2.1 Overview

Variation map 214 is an XML file which contains a hierarchical data structure describing a scenario to be performed. It is loaded, parsed and executed by MCF 204. The syntax of variation map 214 is configured such that it is easy to author it manually, as well as generate it automatically using authoring tools (e.g. SQRTS).

Variation map 214 contains group and variation nodes. It represents a tree of group nodes and variation nodes which combine to form an acyclic graph. Each group node in the variation map can contain an arbitrary number of other group nodes which can reference arbitrary number of variation nodes. Variation nodes cannot contain other variation or group nodes (however, they can contain other auxiliary nodes). A variation node associates a unique variation ID and data belonging to a particular variation with a class and/or method(s) to be invoked in response to variation execution. Group node is used to associate resources with a number of child groups and variation nodes. Associating resources in this manner may be handy when some resource needs to be created prior to execution of some variations and destroyed after.

There is also meta information associated with the entire variation map which is submitted through parameters/attributes in the variation map root node. It can describe which component is associated with the variation map, who is the owner of a specific scenario, etc. The recommended name of the variation map file 214 is:

[Company.][Department.]Product.Technology.Component.xml; for example:

SMX.Test.Monitoring.ComProvider.xml

FIGS. 3, 4 and 6-8 illustrate examples of variation maps. A variation map (e.g., a variation map node—the root node of a variation map) can contain a sub-tree of groups and a list of variations in any order. Variations (e.g., variation nodes) may be terminal nodes that can't contain any other group or variation nodes. However, they may be configured to contain some other auxiliary nodes and attributes, as described below in more detail.

Group nodes can reference sets of variation nodes in any order through ‘varref’ nodes.

Group nodes and ‘varref’ nodes should not be mixed on one level. Their order is important. Basically they are executed in order they appear in the variation map.

2.2.2 Attributes

A variation map may be defined to include any one or more of the attributes listed in Table 3 below. The nodes within a variation map for which each attribute (varmap, grp, var, remarks, varref, rec, fnc) may be used are illustrated in Table 4 below.

TABLE 3
Variation Map Attributes

| Attribute | | |
|---|---|---|
| name | Description | Value Type |
| act | Active - specifies whether | Boolean(*) |
| | particular node is active or inactive | |
| assembly | Specifies user's plug-in assembly | String |
| | name | |
| bugid | Associated bug id | String |
| cls | Class - specifies a class name | String |
| contact | Specifies e-mail alias of contact | String |
| | person or Group | |
| dsc | Short description | String |
| gid | Group ID | Integer |
| hibernateAfter | Causes the system to hibernate after n seconds | Integer, |
| | in the Run( ) method. | seconds |
| impersonateCommandLine | Specifies if the command line | Boolean |
| | switch/user should be used or not. | |
| impersonateUserGroup | Specifies a user group to be | String |
| | impersonated during the Run | |
| | method. | |
| key | Key (in key/value pair) | String |
| lvl | Level - specifies a level | Integer |
| name | Specifies a method name | String |
| owner | Specifies e-mail alias of owner | String |
| pause | Pause on error | Boolean(*) |
| set | Set - specifies a set (see ‘Unique | Integer |
| | ID’) | |
| standByAfter | Causes the system to stand-by after n seconds | Integer, |
| | in the Run( ) method. | seconds |
| timeout | Time out - expected time to | Integer, ms |
| | execute. Test is aborted after this | |
| | period. | |
| vid | Variation ID - specifies a variation | Integer |
| | ID | |

(*‘true’ or ‘false’ strings)

TABLE 4
Attribute Usage

| | varmap | grp | var | remarks | varref | rec | fnc |
|---|---|---|---|---|---|---|---|
| act | | O | O | | | | |
| assembly | M | | | | | | |
| bugid | | | O | | | | |
| cls | | O | M | | | | |
| contact | M | | | | | | |
| dsc | M | O | M | | | | |
| gid | | O | | | | | |
| hibernateAfter | | | O | | | | |
| impersonateCommandLine | | | O | | | | |
| impersonateUserGroup | | | O | | | | |
| key | | | | | | O | |
| lvl | | | M | | O | | |
| name | | | | | | | M |
| owner | M | | | | | | |
| pause | | O | O | | | | |
| set | | | M | | O | | |
| standByAfter | | | O | | | | |
| timeout | | O | O | | | | |
| vid | | | M | | O | | |

(M—Mandatory attribute, O—Optional attribute)

2.2.2.1 Key

Records and keys are described above in relation to FIGS. 6-8. The following portion of a variation map illustrates an example of how records and keys may be used.

<var set=“1” lvl=“1” vid=“1” cls=“SomeNameSpace.MyVar1”
dsc=“Some

variation 1”>

<rec>Default key value 1</rec>
<rec>Default key value 2</rec>
<rec key=“”>Default key value 3</rec>
<rec key=“P0”>Value 1</rec>
<rec key=“P0”>Value 2</rec>
<rec key=“P1”/>

</var>

The default key is an empty string. Note that there is a simplified form for values with a default key, as shown in the following example:

<rec>Default key value 2</rec>
<rec key=“”>Default key value 3</rec>

The first record in this example has the same (empty/default) key as the second one.

2.2.2.2 Time Outs

A time-out can be specified using the ‘timeout’ attribute. It can be specified using any of a plurality of units such as, for example, milliseconds (in some systems, however, the resolution of the timer may only be about 50 ms). If execution time exceeds a specified time-out, a failure is reported.

2.2.2.3 Bug ID

This attribute causes the bug id to be logged at the end of the test case. It also may provide support for differentiating between new and known failures.

2.2.3 Nodes

As illustrated in Figs. A and B, a variation map may include a plurality of different types of nodes, such as, for example, any of the plurality of types of nodes listed in Table 5 below, which describes the function of each type of node. The usage of each of these types of nodes with respect to the structural nodes of the variation map (e.g., varmap, grp, var) are illustrated below in Table 6, and some of these nodes are described in more detail below.

TABLE 5
Nodes of a Variation Map

| Node | |
|---|---|
| name | Description |
| varmap | Root node for group nodes and variation nodes tree |
| varref | Variation reference |
| grp | Group Node |
| var | Variation Node |
| remarks | Remarks |
| rec | Record - stores key/value pair |
| fnc | Associated function |

TABLE 6
Node Usage

| | varmap | grp | var |
|---|---|---|---|
| grp | M(*) | O(*) | |
| var | M(*) | | |
| remarks | | O | O |
| varref | | O | |
| fnc | | | O |
| rec | | O | O |

(O—optional, M—mandatory, *for more details on ‘varmap’, ‘group’ and ‘var’ nodes relationship see corresponding sections)

2.2.3.1 Group

Group nodes can contain references to variation nodes and can include other group nodes, although inclusion of group and variation references in one group is not recommended. For example, the following portion of a variation map (which omits some attributes for clarity), ‘MyClass2’ class is responsible for creation of some resource which is consumed by variations 2.1.3 and 2.2.3, the child variations of the group for which MyClass2 is specified:

<var set=″1″ lvl=″1″ vid=″1″ .../>
<var set=″1″ lvl=″1″ vid=″2″ .../>
<var set=″1″ lvl=″2″ vid=″1″ .../>
<var set=″2″ lvl=″1″ vid=″3″ .../>
<var set=″2″ lvl=″2″ vid=″3″ .../>
<grp>

<grp>

<varref set=″1″ .../>
<varref set=″1″ .../>

</grp>
...
<grp cls=″MyClass2” ...>

<varref set=″2″ .../>
<varref set=″2″ .../>

</grp>

</grp>

Group node has a number of attributes (e.g., any of those listed in Table 3 above). Class attribute specifies a class which contains method(s) to be invoked during group node execution. Referring to FIG. 2, execution engine 208 creates an instance of the class referenced by class attribute in the group node (if specified such as, for example, <grp cls=“MyClass”>). Either of the interfaces supporting Setup and Cleanup methods may be implemented (Run and Verify methods are not implemented on group classes), but you can opt not to implement any (the usefulness of such class is questionable though).

Cleanup method might be very useful in cases in which a resource created by some group and consumed by child nodes should be cleaned up explicitly at the end of group node execution (e.g., resources like data base connections, sockets, etc.). Unlike in C++ and some other object oriented (OO) languages, in which you can count on run-time support that promises to clean up your resources applying deterministic destruction, such clean up cannot be relied upon in CLR's case because the order and timing of destruction is not promised by CLR (non-deterministic destruction is an attribute of the underlying platform itself, not the language in which the framework/custom code is implemented).

2.2.3.2 Variation

Each variation node has an assigned Unique ID (UID) which consists of three values: set, level and variation ID. When editing variation map manually, one should assure that no two variations share a same UID. The following are examples of variation nodes, in which some attributes are omitted for clarity:

<var set=“1” lvl=“1” vid=“1” cls=“SomeNameSpace.MyVar1”>

<rec key=“P0”>Resource 1</rec>
<rec key=“P0”/>
<rec key=“P1”/>
<rec key=“”/>
<fnc name=“MyFunc2” />
<fnc name=“MyFunc0” />

</var>
<var set=“1” lvl=“1” vid=“2” cls=“SomeNameSpace.MyVar1”>

<rec key=“Param1”>Value 1</rec>
<rec key=“Param2”>Value 2</rec>
<rec key=“Param3”/>
<fnc name=“MyFunc1” />
<fnc name=“MyFunc2” />
<fnc name=“MyFunc1” />
<fnc name=“MyFunc0” />

</var>

A variation node can have several attributes and auxiliary sub-nodes. It cannot include other variation or group nodes.

Class attribute has a similar function to that employed by group node. One can specify a set of one or more methods in the variation node, and implement some or all of the Setup, Run, Verify, Cleanup methods. If a method specified in variation node refers to static method in the class, then no instance of the specified class will be created. If the method refers to an instance method, then an instance of the class will be created and the specified method will be invoked on the instance. If at least one of the Setup, Run, Verify, Cleanup methods are implemented, then an instance of the class will be created.

A remarks node allows a user to attach arbitrary string information to a node of a variation map. A developer can also opt not to specify any method, which effectively means the developer has opted to implement one of the interfaces supporting Setup, Run, Cleanup, Verify methods.

2.2.3.2.1 Methods

Each variation node can reference [0..N] methods which will be executed in specified order, for example:

<var set=″1″ lvl=″1″ vid=″1″ cls=″MyCls1″ >

<fnc name=”My Method1” />
<fnc name=”MyMethod2” />
<fnc name=”MyMethod3” />

...

</var>

If implemented, Setup and Run are invoked prior to any proprietary methods specified in a ‘fnc’ node; Verify and Cleanup are executed after. In some embodiments, proprietary methods cannot be specified for a group node.

2.2.3.3 Records

As noted above, a record node of a variation map may be used to specify values and/or patterns of values to be passed into testing code (e.g., a method or another resource). The key attribute may be used for this purpose.

It is possible to specify an arbitrarily long set of key/value pairs under a variation node. As noted above, keys are not unique, as it is possible to associate multiple values with one key. Default key is an empty string that you can specify explicitly, e.g.:

<rec key=″″>Some value</rec>;

or in a simpler fashion by not specifying a key attribute at all, e.g.:

<rec>Some value 1</rec>
<rec>Some value 2</rec>

Records may utilize parameterized constructors for data classes as in the following example:

<var set=″1″ lvl=″1″ vid=″2″ cls=″SomeNameSpace.MyVar1″>

<rec>Value 1</rec>
<rec> Value 1</rec>
<rec key=””> Value 1</rec>
<rec key=″Param1″>Value 1</rec>
<rec key=″Param2″>Value 2</rec>
<rec key=″Param3″/>

</var>

A method of a corresponding variation can retrieve the data specified in the preceding example, during run-time, using keys to fetch corresponding value of strings or by enumerating key collection. This technique might be especially useful when the essence of several scenarios only differs slightly.
2.2.4 Plug-Ins

Custom plug-in components (e.g., 212) are assemblies developed by users of the framework 204. They are loaded dynamically and executed by the framework. In order for an assembly to be invoked, a framework's user should specify a component's name explicitly in the variation map. A component might be implemented in any CLR compliant language (e.g. C#, VB.Net, Perl, MC++/C++, etc.). As described above, each plug-in assembly contains a number of classes which implement scenario logic. Execution engine 208 is configured to parse the plug-in assembly 212 at run-time, and look for classes and methods specified in variation map. If a specified method or class is not found, then a run-time error is reported. The recommended name of the plug-in file name is:

[Company.][Department.]Product.Technology.Component.dll; for example,

SMX.Monitoring.ComProviderTest.dll

2.2.5 Error Handling/Reporting

Error reporting in the framework 204 may be entirely based on CLR's exception handling, thus eliminating any possibility for an execution error to escape undetected. To report an error during execution of group code or variation code, testing code (e.g., of a custom assembly) should throw an ApplicationException with appropriate message. By doing so, the framework is able to distinguish between “intentional” and “unintentional” exceptions. No exception should happen during normal (positive/variation success) execution of variation, which indicates success of variation execution. If an exception is expected by the variation developer (e.g., as in many negative cases), it should not propagate boundaries invoked by the framework method of a custom plug-in, and thus should be handled inside the variation plug-in itself. However, one should be careful to not catch all exceptions unintentionally. If some exception still propagates, the framework will catch and report it as a failure. An execution of the corresponding node will be aborted. A full stack trace and an exception/failure report may be provided at a chosen logging output location. If no exceptions propagate within variation method boundaries, a variation method invocation should be considered successful.

2.2.6 Deployment/Invocation

The framework 204 can be deployed in any directory on the system where CLR is installed. All custom plug-ins and corresponding scenario files should be placed in child directories, and dependent plug-ins and scenario files should be put in one directory. Assuming that ‘fmk.exe’ is a framework executable, the following line will start execution of specified scenario:

/m[ap]:.\csplugin\varmap.xml /setup /dbglvl:8 /set:1 /loop:2 /iter:2

During execution, framework 204 attempts to find an assembly in the same directory where the variation map that specifies the assembly file is located.

2.3 Command Line Parameters

Almost all command line parameters have direct correspondence with execution engine states, which they can alter. When referring to a default state of particular command line parameter, the corresponding default state of the execution engine 208 is implied. Keep in mind that you can also alter state through execution engine component parameters. Changing state (through command line parameters or execution engine parameters) can affect traversal/execution of a scenario. Examples of command line parameters are listed and described in Table 7 below, followed by a description of the usage of several of the parameters.

TABLE 7
Command Line Parameters

| | Description | Param Type | Default |
|---|---|---|---|
| /? | Prints usage help | N/A | N/A |
| /a[ppend] | Specifies whether to append to existing | Boolean | True |
| | log file | | |
| /cleanup | If set to false suppresses | Boolean | True |
| | Cleanup method invocation (if | | |
| | implemented). It affects only | | |
| | execution of group node. | | |
| /dbgloc | Specifies output location | Numerical, | StdOut AND |
| | | Decimal, | DbgOut (For |
| | | Unsigned | console |
| | | | environment) |
| | | | otherwise none |
| /dbglvl | Specifies level of output | Numerical, | Error AND |
| | | Decimal, | Always |
| | | Unsigned | |
| /iter | Specifies how many times | Numerical, | 1 |
| | specific Variation will be | Decimal, | |
| | activated (Setup, Run, Verify, | Unsigned | |
| | Cleanup will be engaged | | |
| | sequentially if exist and | | |
| | permitted by other settings. | | |
| | The same applicable if method is specified | | |
| | instead) | | |
| /l[evel] | Specifies level. Only those | Numerical, | Not specified |
| | variations which match this | Decimal, | |
| | level will be executed | Unsigned | |
| /log[file] | Specifies log file. | String | N/A |
| /logger | XSL transformation to be used | Bvt, | Summary, htmlog |
| | | summary, | |
| | | htmllog, | |
| | | noparsing and | |
| | | mcf | |
| /loop | Specifies how many times the | Numerical, | 1 |
| | whole execution will be | Decimal, | |
| | repeated | Unsigned | |
| /m[ap] | Specifies variation map file | String | N/A |
| | name | | |
| /password | The user password for user | String | Not specified |
| | impersonation | | |
| /pause | Sets reaction on error | String, enum | ‘never’ |
| /pwrstate | Enables/disables power state | Boolean | True |
| | transitions by varmap | | |
| /remark | Specifies if remarks are to be | Boolean | False |
| | printed. | | |
| /repro | Specifies if repro line is to be | Boolean | True |
| | printed. | | |
| /s[et] | Specifies set. Only those | Numerical, | Not specified |
| | variations which match this set | Unsigned | |
| | will be executed. | | |
| /seed | Specifies seed number | Numerical, | Random |
| | | Decimal, | |
| | | Unsigned | |
| /setup | If set to false suppresses Setup | Boolean | True |
| | method invocation (if | | |
| | implemented). It affects only | | |
| | execution of group node. | | |
| /stats | If set to true prints all output | Boolean | False |
| | without execution of variations | | |
| /timeout | Timeout for the whole | Numerical | 1800 |
| | execution in seconds | | |
| /user | Causes MCF to impersonate | String | Not specified |
| | the given user | | |
| /v[ar] | Specifies variation ID. Only | Numerical, | Not specified |
| | those variation which match | Decimal, | |
| | this variation id will be executed. | Unsigned | |
| /pwrauto | Enables/disables the random | Boolean | False |
| | power state transitions | | |

2.3.1 /?
Usage:/?

This switch prints out to the screen the usages for all command line arguments. This switch is not reported as a part of repro line.

2.3.2 /dbgloc

Usage:/dbgloc:Number

This command line argument specifies the location to which any output messages are written. The number is decimal. Examples of defined output locations are shown in Table 8 below:

TABLE 8
Defined Output Locations

| Value | | |
|---|---|---|
| (Decimal) | Bit Position | Output Location |
| 0 | — | NONE |
| 1 | 0 | DBGOUT (OutputDebugString) |
| 2 | 1 | STDOUT (Console) |
| 4 | 2 | LOG (Log file) |
| 8 | 3 | VERBOSE LOG (Verbose log file, |
| | | dumps all output independently of/ |
| | | dbglvl) |
| 16 | 4 | XML (reserved) |
| 32 | 5 | DATABASE (reserved) |

Note that the value of each debug message is a binary bit position (DBGOUT output is controlled by bit 0, STDOUT by bit 1, etc). It is possible to specify multiple debug locations by performing a logical OR on the bit values. For example, the value 3 would direct output to both DBGOUT and STDOUT, e.g.:

/outloc:3

This switch is reported as a part of repro line if was provided and was not default value.

2.3.3 /dbglvl

Usage: /dbgtlvl:Number

This command line argument specifies which types of messages are to be written out to the logging locations (depending on message's output level), for example, by specifying the type(s) of messages by a number in accordance with Table 9 below. The number is decimal.

TABLE 9
Message Type Levels

| Value | | |
|---|---|---|
| (Decimal) | Bit Position | Output Level |
| 1 | 0 | ALWAYS messages |
| 2 | 1 | ERROR messages |
| 4 | 2 | WARNING messages |
| 8 | 3 | TRACE messages |
| — | 6-15 | RESERVED |
| — | 16-31 | CUSTOM messages |

Default state of the system is ‘ALWAYS|ERROR’. It is possible to set other states, but it is not possible to disable/change ALWAYS or ERROR settings for the framework. If WARNING level (e.g., decimal value=4) is set and three messages are printed with, for example, ERROR, WARNING and TRACE levels, respectively, then only the messages having the WARNING and ERROR levels will be printed. This approach also allows combining flags so that multiple levels of output are permitted (e.g., ERROR|WARNING) and associating multiple categories with a message. An example of using the command line parameter to combine flags is as follows:

/dbglvl:3

Always and Error messages are output (e.g. printed because Decimal 3==Binary 11, which specifies Always and Error messages (see Table 9)).

Note that the value specifying each output message type represents a binary bit position (ALWAYS message are controlled by bit 0, ERROR messages by bit 1, etc). It is possible to specify multiple output levels by performing a logical OR on the bit values. For example, the value 9 (binary 1001) would turn on ALWAYS and TRACE messages. This switch is reported as a part of repro line if was specified in the command line and was not a default value. TRACE switch affects the framework's logging output. When it is specified, the framework will trace all entries and exits in and from plug-in methods it calls (described below in more detail) and provide full stack if exception occurs.

2.3.4 /iter

Usage: /iter:Number

This argument specifies the number of times each Variation is to be run. Each Variation will run the specified number of times before the next Variation in the scenario starts running, e.g., (with some nodes omitted for clarify):

<var set=“1” lvl=“1” vid=“1” .../>
<var set=“1” lvl=“1” vid=“2” .../>
<var set=“1” lvl=“1” vid=“3” .../>
<grp>

<varref/>

</grp>

Given a scenario that has three (3) Variations all in set 1—V1, V2, V3, the command line parameter: /iter:2 will result in the following execution order: V1, V1, V2, V2, V3, V3. This switch is reported as a part of repro line if was provided and was not default value.

2.3.5 /log[file]

Usage: /log[file]:File

This switch specifies log file name. It can have absolute or relative path. Usual file name/path restrictions of OS apply.

2.3.6 /logger

Usage: /logger[:bvt|summary|htmllog|noparsing|mcf]

This parameter (i.e., switch) specifies the XSL transformation to be used (bvt, summary, htmllog, noparsing). Different XSL transformations can be used separated by commas:

summary: produces a summary html log file from WTT log file;

htmlog: produces a detailed html log file from WTT log file;

noparsing: does not perform the WTT log file parsing; and

mcf: Uses build in MCF logger (*It cannot be combined with other options).

2.3.7 /logv[file]

Usage: /logv[file]:File

This switch specifies a verbose log file name. A verbose log logs all categories of output independently of ‘/dbglvl’ set. It can have absolute or relative path. Usual file name/path restrictions of OS apply.

2.3.8 /loop

Usage: /loop:Number

This parameter specifies the number of times the entire scenario sequence specified in a variation map is to be run. The complete set of variations specified in the variation map will be run before execution of the next complete set begins. For example, given a scenario that has three (3) Variations (V1, V2 and V3) all in one set, the command line parameter: /loop:2 will result in the following execution order:

V1, V2, V3, V1, V2, V3.

Further, the command line parameters: /iter:2 /loop:2 will result in following execution order:

V1, V1, V2, V2, V3, V3, V1, V1, V2, V2, V3, V3.

This switch is reported as a part of repro line if was specified in the command line along with a non-default value.

2.3.9 /g[id]

Usage:

/g[id]:Number

Each group can be associated with an ID, which can be used at run-time to specify the group and parameter values to associate with the group. Only matching groups and its children will be executed.

2.3.10 /s[et], /l[evel], /v[ar]

Usage:

/s[et]:Number

/l[evel]:Number

/v[ar]:Number

Each variation (which is the atomic scenario run by MCF 204) has a unique combination of set, level and variation ID assigned to it at creation by the scenario developer—this defines a Unique ID for that variation. The use of these three command line switches allows for the filtered selection of variation with specified UIDs.

2.3.11 /setup

Usage: /setup[:true|false]

If this switch is set to FALSE, the framework will suppress execution of the ‘Setup’ method. (Only for nodes which opted to implement corresponding interface, otherwise this setting has no effect). This switch is reported as a part of a repro line if was specified along with a non-default value.

2.3.12 /cleanup

Usage: /cleanup[:true|false]

If this switch is set to FALSE, the framework will suppress execution of the ‘Cleanup’ method (only for nodes which opted to implement corresponding interface, otherwise this setting has no effect). This switch is reported as a part of repro line if it was specified along with a non-default value.

2.3.13 /run

Usage: /run[:true|false]

If this switch is set to FALSE, the framework will suppress execution of the ‘Run’ method (only for nodes which opted to implement corresponding interface, otherwise this setting has no effect). This switch is reported as a part of repro line if it was specified along with a non-default value.

2.3.14 /m[ap]

Usage: /m[ap]:File

The switch specifies a variation map file. It can have absolute or relative path. Usual file name/path restrictions of OS apply. Need to be provided explicitly. This switch is always reported as a part of repro line.

2.3.15 /password

Usage: /password:user_password

This parameter specifies the user password for user impersonation. It must be used in combination with the /user switch.

2.3.16 /pwrauto

Usage: /pwrauto[:true|false]

This parameter enables/disables random power state transitions. If enabled, MCF will randomly choose one variation from the varmap and it will initiate a power transition during the method Run(IContext context) if no other variation defines a power transition in the varmap. Default value is false.

2.3.17 /pwrstate

Usage: /pwrstate[:true|false]

This parameter enables/disables power state transitions by varmap. If enabled MCF will perform the power transitions specified in the varmap; otherwise, power transitions defined in the varmap will be ignored. Default value is true.

2.3.18 /remark

Usage: /remark [:true|false]

This switch specifies if remarks are to be printed.

2.3.19 /repro

Usage: /repro[:true|false]

This switch specifies if repro line is to be printed.

2.3.20 /sharedwrite

Usage: /sharedwrite[:true|false]

This parameter enables sharing of logging files for writing by multiple processes. It is not synchronized. If this setting is enabled, all subsequent processes sharing the same file should set this parameter in true state as well.

2.3.21 /timeout

Usage: /timeout:seconds

This parameter changes the default timeout for the whole execution from a default value (e.g., 1800 seconds (30 minutes)) to the specified value in seconds. Notice that there is no way to disable this feature. If no timeout is specified and the execution exceeds the default value, then MCF 204 will abort the test after the default time.

2.3.22 /user

Usage: /user:username

This parameter causes MCF 204 to impersonate this user in the ‘Run’ method for all variations except by those which has the attribute impersonateCommandLine set to false. It must be combined with the ‘password’ argument.

2.3.23 /stats

Usage: /stats[:true|false]

If this switch is set to TRUE, framework 204 just lists the variations that are selected by the remaining command line arguments and will not execute them. For example: /set:1 /stats:false runs all variations belonging to set 1 (stats flag is just ignored); /set:1 /stats lists all variations belonging to set 1 (but does not execute them). It is the same as /set:1 /stats:true. This switch is reported as a part of repro line if was provided and was not default value.

2.3.24 /pause

Usage: /pause: Never|Marked|Always

The above values have the following affect on this parameter:

Never—proceeds if error happens;

Marked—pauses only if corresponding node has ‘pause’ attribute on; and

Always—pauses always if error happens.

Note: The parameter name is case sensitive.

2.3.25 /seed

Usage: /seed:Number

This switch specifies the seed to be used for random data generation. Seed number makes it possible to reproduce execution flow where random generation were used. If it is not specified, a random seed is generated. The value of the seed used in a scenario execution is always logged out. It is possible to recreate a scenario execution by using consistent command line arguments and specifying the same seed value using this argument. This switch is always reported as a part of repro line.

2.3.26 /a[ppend]

Usage: /a[ppend][:true|false]

If this switch is set to TRUE, the framework will append to existing log file if one is specified. This switch is reported as a part of repro line if was provided and was not default value.

2.4 Random Data Generation

A developer can utilize a set of methods on ‘IFramework Framework’ property of IContext interface, which is passed as a parameter. ‘NextString’ methods allows generation of string on base of pattern which follows RegEx syntax (see below).

2.4.1 Settings

Special characters and sequences are used in writing patterns for regular expressions. The following Table 20 describes and gives an example of the characters and sequences that can be used.

TABLE 10
Regular Expressions

| Character | Description |
|---|---|
| \ | Marks the next character as either a special character or a literal. For |
| | example, “n” generates the character “n”. “\n” generates a new-line |
| | character. The sequence “\\” generates “\” and “\(” generates “(”. |
| * | Generates the preceding character zero or more times. For example, |
| | “zo*” generates either “z” or “zoo”. |
| + | Generates the preceding character one or more times. For example, |
| | “zo+” generates “zoo” but not “z”. |
| ? | Generates the preceding character zero or one time. For example, |
| | “a?ve?” generates the “ave” or “a” or “ye”. |
| . | Generates any single character except a newline character. |
| (pattern) | Generates pattern. The generated string will be remembered by |
| | \number backreferences. To match parentheses characters ( ), use |
| | “\(” or “\)”. For example, “(a\|b)\1” generates “aa” or “bb”, but not |
| | “ab” or “ba”. |
| (?<name>pattern) | Generates pattern. The generated string will be remembered by |
| (?’name’pattern) | named backreference using name name. For example, |
| | “(?<abc>Hello!)\k<abc>” generates “Hello!Hello!”. |
| (?:pattern) | Generates pattern. The generated string will not be remembered. |
| X\|y | Generates either x or y. For example, “z\|food” generates “z” or |
| | “food”. “(z\|f)oo” generates “zoo” or “foo”. |
| {n} | n is a nonnegative integer. Generates exactly n times. For example, |
| | “o{2}” generates “oo”. |
| {n,} | n is a nonnegative integer. Generates exactly n times. |
| {n,m} | m and n are nonnegative integers. Generates at least n and at most m |
| | times of preceding character or grouped item. For example, |
| | “o{1, 3}” generates “o”, “oo”, or “ooo” |
| {=n,m} | m and n are nonnegative integers. Generates at least n and at most |
| | m identical copies of preceding character or grouped item. For |
| | example, “[a-b]{=3}” generates “a”, “aa”, “aaa”, “b”, “bb”, “bbb”. |
| | But “[a-b]{1, 3}” generates those strings and other strings “ab”, |
| | “abb”, “aba”, etc. |
| [xyz] | A character set. Generates any one of the enclosed characters. For |
| | example, “[abc]” generates “a”. |
| [\hat{ }xyz] | A negative character set. Generates any character not enclosed. For |
| | example, “[\hat{ }abc]” generates the “p”. |
| [a-z] | A range of characters. Generates any character in the specified |
| | range. For example, “[a-z]” generates any lowercase alphabetic |
| | character in the range “a” through “z”. |
| [\hat{ }m-z] | A negative range characters. Generates any character not in the |
| | specified range. For example, “[m-z]” generates any character not in |
| | the range “m” through “z”. |
| [:name:] | Generates string defined by macro name. See section Macros for |
| | detail. |
| \d | Generates a digit character. Equivalent to [0-9]. |
| \D | Generates a nondigit character. Equivalent to [\hat{ }0-9]. |
| \f | Generates a form-feed character. |
| \n | Generates a newline character. |
| \r | Generates a carriage return character. |
| \s | Generates any white space including space, tab, form-feed, etc. |
| | Equivalent to “[\f\n\r\t\v]”. |
| \S | Generates any nonwhite space character. Equivalent to |
| | “[\hat{ }\f\n\r\t\v]”. |
| \t | Generates a tab character. |
| \v | Generates a vertical tab character. |
| \w | Generates any word character including underscore. Equivalent to |
| | “[A-Za-z0-9_]”. |
| \W | Generates any nonword character. Equivalent to “[A-Za-z0-9_]”. |
| \num | Generates the numth indexed backreference, where num is a positive |
| | integer. |
| \k<name> | Generates named backreference, where name is the backreference |
| \k’name’ | name. |
| \xn | Generates n, where n is a hexadecimal escape value. For example, |
| | “\x41” generates “A”. Allows ASCII codes to be used in regular |
| | expressions. |

2.4.2 Macros

The following Table 21 describes predefined macros, which can be used to generate values for regular expressions.

TABLE 11
Predefined Macros

| Name | Equivalent |
|---|---|
| alpha | [a-zA-Z] |
| upper | [A-Z] |
| lower | [a-z] |
| digit | [0-9] |
| xdigit | [A-F0-9a-f] |
| alnum | [A-Za-z0-9] |
| space | [\t] |
| print | [\x20-\x7F] |
| punct | [,;.!‘'’] |
| graph | [\x80-\xFF] |
| blank | [\t\r\n\f] |
| guid | [A-F0-9]{8 }(−[A-F0-9]{4}){3 }−[A-F0-9]{12} |

Having now described some illustrative embodiments of the invention, it should be apparent to those skilled in the art that the foregoing is merely illustrative and not limiting, having been presented by way of example only. Numerous modifications and other illustrative embodiments are within the scope of one of ordinary skill in the art and are contemplated as falling within the scope of the invention. In particular, although many of the examples presented herein involve specific combinations of method acts or system elements, it should be understood that those acts and those elements may be combined in other ways to accomplish the same objectives. Acts, elements and features discussed only in connection with one embodiment are not intended to be excluded from a similar role in other embodiments. Further, for the one or more means-plus-function limitations recited in the following claims, the means are not intended to be limited to the means disclosed herein for performing the recited function, but are intended to cover in scope any equivalent means, known now or later developed, for performing the recited function.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

What is claimed is:

1. A system for executing a software test on at least a portion of a software application, comprising:
at least one testing module defining one or more functions to perform on the at least portion of software code; and
a data structure separate and distinct from the at least one testing module, the data structure specifying verification data to be applied by the at least one testing module.

2. The system of claim 1, wherein the data structure is formatted in accordance with an extensible markup language.

3. The system of claim 1, further comprising:
a testing framework operative to execute the software test based on the data structure, wherein the testing framework is operative to receive an instruction to execute a software test using the data structure, and wherein the testing framework controls execution of the software test based on the data structure in response to receiving the instruction.

4. The system of claim 3, wherein the instruction specifies one or more parameters corresponding to the data structure, and
wherein the testing framework is operative to control execution of the at least one testing module based at least in part on a value of the one or more parameters.

5. The system of claim 4, wherein the data structure includes a reference to the at least one testing module, and
wherein the testing framework is operative to interpret the data reference, including generating values of the verification data and identifying the at least one testing module from the reference and operative to execute the at least one testing module using the generated values.

6. The system of claim 1, wherein the at least one testing module includes a plurality of testing modules, and wherein the data structure defines an order in which the testing modules are to be executed and/or a number of times each testing module is to be executed.

7. The system of claim 1, wherein the data structure specifies a data pattern to be used to generate values of the verification data, the system further comprising:
a testing framework operative to execute the software test based on the data structure, including generating values of the verification data based on the specified data pattern.

8. The system of claim 7, wherein the testing framework is operative to generate random values based on the specified data pattern.

9. The system of claim 7, wherein the specified data pattern is one of the following types of data patterns: a simple name-value pair; a regular expression; a permutation of multi-key value pairs; a Pairwise Independent Combinatorial Testing pattern; a complex data pattern.

10. A method of executing a software test on at least a portion of a software application, comprising acts of:
(A) interpreting a data structure specifying verification data to be applied by at least one testing module, the at least one testing module defining one or more functions to perform on the at least portion of software code;
(B) in response to the act (A), executing the at least one testing module one or more times using the verification data.

11. The method of claim 10, wherein the data structure includes a reference to the at least one testing module,
wherein the act (A) comprises interpreting the data reference, generating values of the verification data and identifying the at least one testing module from the reference, and
wherein the act (B) comprises executing the at least one testing module using the generated values.

12. The method of claim 10, wherein the data structure specifies a data pattern to be used to generate values of the verification data, the method further comprising:
(C) generating values of the verification data based on the specified data pattern.

13. The method of claim 12, wherein the act (C) comprises generating random values based on the specified data pattern.

14. The method of claim 12, wherein the specified data pattern is one of the following types of data patterns: a simple name-value pair; a regular expression; a permutation of multi-key value pairs; a Pairwise Independent Combinatorial Testing pattern; a complex data pattern, and
wherein the act (C) comprises generating values of the verification data based on the type of the specified data pattern.

15. The method of claim 10, further comprising:
(C) receiving an instruction to execute a software test using the data structure,
wherein the act (A) is performed in response to the act (C), and
wherein the act (B) comprises executing the at least one testing module based at least in part on a value of the one or more parameters.

16. A computer-readable medium having computer-readable signals stored thereon that define a data structure for testing at least a portion of software code, the data structure comprising:
a reference to at least one testing module including one or more functions to perform on the at least portion of software code; and
one or more definitions of verification data to be applied by at least one testing module when performing the one or more functions.

17. The computer-readable medium of claim 16, wherein the data structure is formatted in accordance with an extensible markup language.

18. The computer readable medium of claim 16, wherein the at least one testing module includes a plurality of testing modules, and wherein the data structure defines an order in which the testing modules are to be executed and/or a number of times each testing module is to be executed.

19. The computer readable medium of claim 16, wherein the data structure specifies a data pattern to be used to generate values of the verification data.

20. The computer readable medium of claim 19, wherein the specified data pattern is one of the following types of data patterns: a simple name-value pair; a regular expression; a permutation of multi-key value pairs; a Pairwise Independent Combinatorial Testing pattern; a complex data pattern.
